(19) United States
(12) Patent Application Publication
(10) Pub. No.: US 2010/0209075 A1
(43) Pub. Date: Aug. 19, 2010

(54) DISPLAY APPARATUS AND METHOD FOR DISPLAYING

(76) Inventors: Chung Yong Lee, Pyeongtaek-si (KR); Yang Hee Kim, Pyeongtaek-si (KR)

Correspondence Address: KED & ASSOCIATES, LLP, P.O. Box 221200, Chantilly, VA, 20153-1200, US

(21) Appl. No.: 12/738,910

(22) PCT Filed: Oct. 13, 2008
(86) PCT No.: PCT/KR08/06027

§ 371 Date: Apr. 20, 2010

(30) Foreign Application Priority Data
Oct. 25, 2007 (KR) 10-2007-0107531

(51) Int. Cl. H04N 5/91

(52) U.S. Cl. 386/68; 386/E05.003

(57) ABSTRACT

An apparatus for displaying includes a memory configured to store an image of a recorded material and an information of the recorded material, a displaying unit configured to display the recorded material stored in the memory, a recording managing unit configured to divide the recorded material into one or more recorded materials, and extract one or more start images of the respective divided recorded materials, and a controlling unit configured to control for a user to select a replay time point of the recorded material using the start image extracted by the recording managing unit.

### TECHNICAL FIELD

The present disclosure relates to an image display apparatus, and more particularly, to an image display apparatus and method, which enable users to easily select a view start time of a record program by providing a preview image to users upon view of the record program in a memory.

### BACKGROUND ART

Recently, Personal Video Recorder (PVR) products have been developed and marketed which include a built-in storage medium such as hard disk and record/replay a television (TV) broadcast material. Particularly, it is expected that the PVR products rapidly replace the existing Video Cassette Recorder (VCR) products according to the full-scale providing of a digital broadcast service.

Due to the rapid development of the PVR products, users can store a desired broadcast program in a hard disk using preset record or general record, and can replay and view the recorded program.

That is, information of prestored record programs is displayed on a prestored record list. When a specific recorded material of the record programs is selected, the replay of a corresponding recorded material starts from a record start time.

However, when a user selects a specific recorded material from a record list, a related art image replay method replays a corresponding recorded material from the record start time of the recorded material. Accordingly, in a case where the replay of the specific recorded material is stopped and thereafter the specific recorded material is again replayed, since the specific recorded material is again replayed from its start time, the user must manually move the replay position of the specific recorded material from the start time to the viewed time.

That is, since the replay of a recorded program is always started from the start time of a recorded material, users must start the replay of the recorded program from a start time and repeatedly view the recorded program or execute a fast forward operation to a desired view position for moving the replay position of the recorded program to a specific position of the recorded program.

Accordingly, it is required that users can freely select a desired view time for a recorded program.

### DISCLOSURE OF INVENTION

### Technical Problem

Embodiments provide an image display apparatus and method, which display at least one image of a recorded material on a screen in order for a user to select the replay time of the recorded material, thereby replaying the recorded material from the replay time corresponding to an image selected by the user.

### Technical Solution

In one embodiment, an image display apparatus includes: a memory configured to store an image of a recorded material and an information of the recorded material; a displaying unit configured to display the recorded material stored in the memory; a recording managing unit configured to divide the recorded material into one or more recorded materials, and extract one or more start images of the respective divided recorded materials; and a controlling unit configured to control for a user to select a replay time point of the recorded material using the start image extracted by the recording managing unit.

In another embodiment, an image display method includes: dividing a recorded material stored in a memory into a plurality of recorded materials, and extracting images corresponding to start times of the respective divided recorded materials; storing the extracted images as preview images of the recorded material; displaying the preview images together when a list of the recorded material is displayed on the displaying unit; and replaying the recorded material from a selected preview image when any one of the preview images is selected.

### Advantageous Effects

Embodiments enable users to easily search and select the replay time of a recorded material through a preview image provided on a record list.

### BRIEF DESCRIPTION OF THE DRAWINGS

FIG. 1 is a block diagram of an image display apparatus according to an embodiment.

FIG. 2 is an exemplary diagram of a user interface for users to select a replay time of a recorded material according to an embodiment.

FIG. 3 is an exemplary diagram illustrating a replay image of a corresponding program on a screen in a case where a recorded material is replayed according to an embodiment.

FIG. 4 is a flowchart of an image display method according to an embodiment.

### MODE FOR THE INVENTION

Reference will now be made in detail to the embodiments of the present disclosure, examples of which are illustrated in the accompanying drawings.

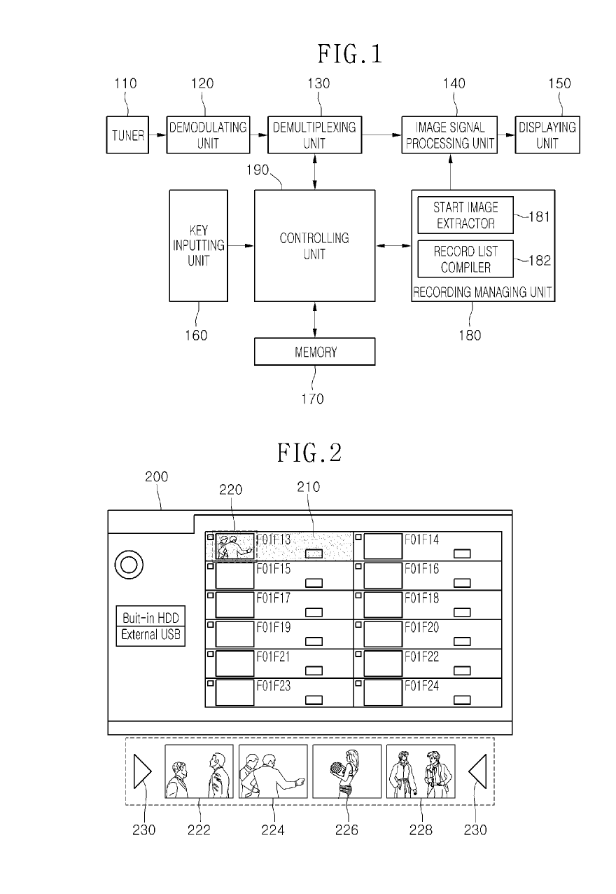

FIG. 1 is a block diagram of an image display apparatus according to an embodiment. FIG. 2 is an exemplary diagram of a user interface for users to select the replay time of a recorded material according to an embodiment.

The image display apparatus is disclosed as a broadcast receiver receiving a Radio Frequency (RF) broadcast signal, but the present invention is limited to this embodiment. An embodiment can be applied to a terrestrial broadcast system, a cable broadcast system, a satellite broadcast system, an Internet broadcast system and a computer network broadcast system. For example, the broadcast systems may include a non-MPEG compatible system of receiving other type of encoded datastream and program characteristic information in other scheme.

Referring to FIGS. 1 and 2, the image display apparatus includes a tuner 110 which is a receiving unit for receiving an external broadcast signal and selects a broadcast signal of a channel which a user desires, a demodulating unit 120 demodulating and correcting the broadcast signal selected through the tuner 110 to change the selected broadcast signal into a transport stream type, a demultiplexing unit 130 demultiplexing the temporally multiplexed transport stream input through the demodulating unit 120 to divide the transport stream into audio information, video information and additional information, and a image signal processing unit 140 decoding an image signal input through the demultiplexing unit 130, changing the decoded image signal to be suitable for an outputtable display format and outputting the changed signal.

The image display apparatus includes a displaying unit 150 displaying an image signal, a memory 170 storing a received image signal, and a recording managing unit 180 extracting the image signal stored in the memory 170, i.e., a portion of the images of the recorded material, and providing the extracted image to a user.

The image display apparatus includes a controlling unit 190 performing control for the replay time of the recorded material to be determined using image information extracted by the recording managing unit 180, for example, an image, a key inputting unit 160 receiving items selected by a user for predetermined image information provided through the recording managing unit 180, and a displaying unit 150 displaying the recorded material.

Particularly, the recording managing unit 180 includes a start image extractor 181 dividing the recorded material into predetermined areas using an image included in the recorded material and extracting the start images of the respective divided areas, and a record list compiler 182 compiling a list of the recorded material stored in the memory 170 using an dynamic image or an image extracted by the start image extractor 181.

The start image extractor 181 extracts a plurality of images having different replay times for the recorded material stored in the memory 170. The image extracted by the start image extractor 181 is a dynamic image or an image.

Herein, in a case where the extracted image for the recorded material is the image, both the information of the recorded material and the extracted images are arranged in the record list compiled by the record list compiler 182. The extracted image for the recorded material may be called a preview image according to the use purpose of the image.

In a case where the extracted image for the recorded material is the dynamic image, the start image extractor 181 may divide the recorded material by preset time, and extract some images from the respective start times of the divided recorded material as a start image. This reason is because the start image of the recorded material is provided for supplying the summary information of the recorded material replayed at a corresponding replay time to a user.

Hereinafter, the capture image or image of any one scene among images included in the recorded material will be described as an example of the start image extracted by the start image extractor 181.

The controlling unit 190 stores information of a broadcast program, preset record or general record for which is selected by a user through the key inputting unit 160, and stores an image signal of the broadcast program in the memory 170. Accordingly, a user can view the image signal stored in the memory 170 as a recorded material.

The recording managing unit 180 extracts and generates the start image of the recorded material on the basis of a preset image generation unit for the stored recorded material. For example, the recording managing unit 180 generates the preview image of the stored recorded material.

Herein, the image generation unit is a point or a time unit (interval) for generation of a start image (or preview image) of a recorded material. For example, a user may optionally set a time interval into ten minutes, twenty minutes and the like. Moreover, the user may optionally correct the set image generation unit later. Furthermore, when there is no image generation unit which is optionally set by the user, a default value may be set into an image generation unit.

Therefore, the recording managing unit 180 generates the preview image of a program under record on the basis of the preset image generation unit, and the generated start images are stored in the memory 170 so as to be in correspondence with a corresponding record program. That is, the preview image may be stored in the same area as an area where the corresponding record program is stored.

When a record list entry command is input through the key inputting unit 160, the controlling unit 190 controls the recorded material compiler 182 in order for a record list including the start image information of the recorded material stored in the memory to be generated.

The recording managing unit 180 extracts the start image or the preview image prestored in the memory 170 according to a control signal of the controlling unit 190, and generates both the record list including the start image or the preview image and information of a corresponding recorded material.

The preview image (start image) may be included in a corresponding record list upon generation of the record list. When a user selects a specific record program after generation of a general record list, only the preview image of a corresponding record program may be extracted, and the extracted image may be displayed on a space on which a corresponding preview image is displayed.

Moreover, only the representative preview images (preview image of record start time) of respective items may be extracted and displayed at the generation initiation of a record list. Subsequently, when a specific record program is selected, a preview image corresponding to the selected program may be extracted and displayed.

That is, as illustrated in FIG. 2, a record list 200 generated by the recording managing unit 180 includes a list display space 210 on which a list of the record program prestored in the memory 170 is displayed, and a preview image display space 220 on which a preview image corresponding to the record program displayed on the list display space 210 is displayed.

Herein, the start image (preview image) that is firstly generated at the start time of a corresponding record program is displayed on the preview image display space 220, and preview images generated in a time order are sequentially displayed.

Moreover, in a state where a preview image is displayed in a time order, a preview image may immediately be moved into a successive preview image according to a command input through the key inputting unit 160.

That is, as illustrated in FIG. 2, in a case where a preview image of a recorded material includes a first start image 222, a second start image 224, a third start image 226 and a fourth start image 228, the first start image 222 is displayed on the preview image display space 220 in the initial screen of a record list, and the second, third and fourth start images 224, 226 and 228 are sequentially displayed with time.

At this point, when a user inputs a preview image movement key 230, highlight start images are sequentially moved.

Accordingly, the user can rapidly easily search the replay start time position of a recorded material in a record list.

Particularly, when a selection command (or replay command) is input through the key inputting unit 160 under display of a preview image, the controlling unit 190 replays the recorded material from a replay time corresponding to the selected preview image.

That is, in the respective preview images, a replay time position of the recorded material for a corresponding image is stored together. When the start image extractor 181 extracts start images for preview, it also extracts the replay time information of the respective start images together.

The recording managing unit 180 stores both the extracted start image and a replay time of the recorded material for the respective start images in the memory 170. When a user selects a specific preview image, the recording managing unit 180 reads out the replay time of a corresponding image and allows the recorded material to be replayed from the selected preview image.

For example, in a case where a generation unit of a start image is a ten-minute unit, it can be estimated that the first start image 222 is the start time of the record program, the second start image 224 is after ten minutes from the start time of the record program, and the third start time 226 is after twenty minutes from the start time.

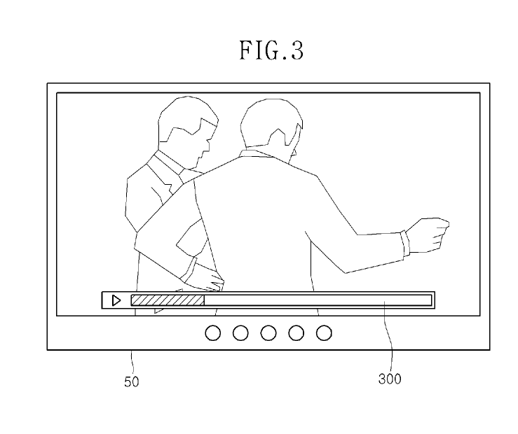

FIG. 3 is an exemplary diagram illustrating a replay image of a corresponding program on a screen in a case where a recorded material is replayed according to an embodiment.

Referring to FIG. 3, when the second start image 224 is selected by a user, a replay is performed from the start time (for example, after ten minutes from a start time) of the second start image 224 of a recorded material, and a progress bar 300 representing the information of the replay time is also displayed together.

The user can easily detect how much of the total replay time of the recorded material has elapsed to a current viewing position by checking the progress bar 300. Herein, various schemes other than the progress bar 300 may be used as a scheme of providing time information which informs the current viewing position.

In this way, the image display apparatus according to an embodiment enables users to easily search and select the replay time of a specific recorded material through preview images provided on a record list, and thus the users can move into a desired specific replay time and replay the specific recorded material. Accordingly, the image display apparatus according to an embodiment can enhance users satisfaction.

Moreover, the image display apparatus according to an embodiment enables the users to easily select the replay time of the recorded material and provides time position information according to the selection of the replay time, and thus the users can easily recognize how much time has elapsed from the start time of a corresponding recorded material to a desired replay time.

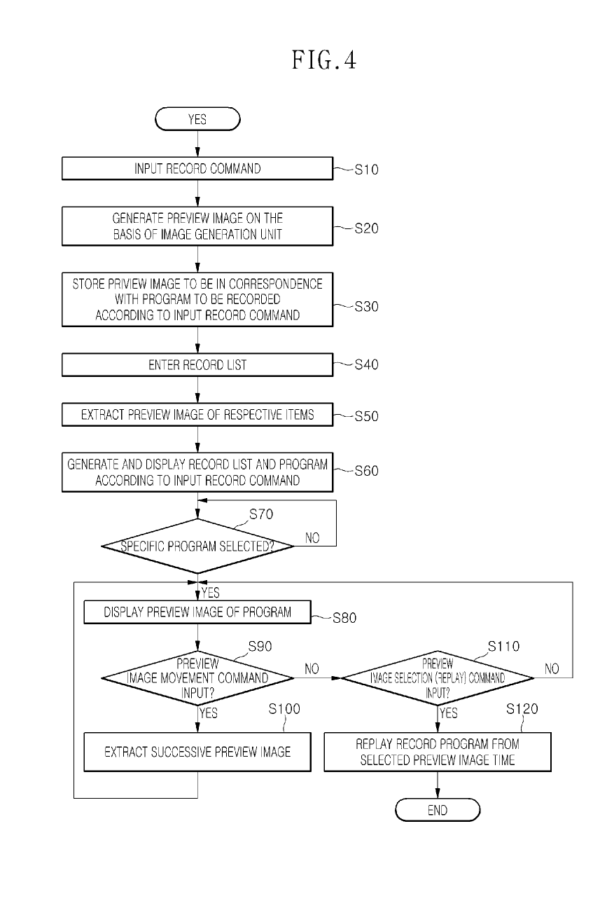

FIG. 4 is a flowchart of an image display method according to an embodiment.

Referring to FIG. 4, when a record command is input from a user in operation S10, the image display apparatus generates the preview image of a program corresponding to the record command in operation S20.

That is, when the user inputs the record command, the image display apparatus generates the preview image of the program to be recorded on the basis of an image generation unit preset by the user.

The image display apparatus stores the generated preview image so as to be in correspondence with the program in operation S30.

When the user inputs a record list entry command in operation S40, the image display apparatus extracts a preview image of each of prestored items in operation S50.

The image display apparatus generates and displays a record list including the preview images of respective record programs on the basis of the extracted preview image in operation S60.

Subsequently, the image display apparatus determines whether a specific program is selected on the record list in operation S70. When the determination result shows that the specific program is selected on the record list, the image display apparatus extracts and displays a preview image of the selected record program in operation S80.

Moreover, the image display apparatus determines whether a preview image movement command is input from the user in operation S90.

When the preview image movement command is input as a result of the determination of the operation S90, the image display apparatus extracts and displays a preview image next to the displayed preview image in operation S100.

When the preview image movement command is not input as a result of the determination of the operation S90, the image display apparatus determines whether a preview image selection command (replay command) is input in operation S110.

When the preview image selection command (replay command) is input as a result of the determination, the image display apparatus replays the selected record program from a corresponding preview image time on the basis of the position information of the preview image selected by the user in operation S120. At this point, the image display apparatus displays time position information on a replay screen for the user to easily detect how much time elapses from the start time of a corresponding record program to a current displaying time.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

Since embodiments can be embodied in an image display apparatus capable of replaying a recorded material, they have industrial applicability.

1. An apparatus for displaying, comprising:
a memory configured to store an image of a recorded material and an information of the recorded material;
a displaying unit configured to display the recorded material stored in the memory;
a recording managing unit configured to divide the recorded material into one or more recorded materials, and extract one or more start images of the respective divided recorded materials; and
a controlling unit configured to control for a user to select a replay time point of the recorded material using the start image extracted by the recording managing unit.

2. The apparatus of claim 1, wherein the recording managing unit comprises:
a start image extractor dividing the recorded material into predetermined areas using an image included in the recorded material, and extracting start images of the respective divided areas; and
a record list compiler compiling a list of the recorded material using the images extracted by the start image extractor.

3. The apparatus of claim 2, wherein the controlling unit controls the recording managing unit for the extracted start images to be displayed in a time order on the record list compiled by the record list compiler.

4. The apparatus of claim 3, wherein the start images displayed on the record list are highlighted according to a input of the user.

5. The apparatus of claim 1, wherein the recording managing unit extracts at least one start image of the recorded material according to an image generation point predetermined by the user.

6. The apparatus of claim 1, wherein the recording managing unit stores informations of starting times of the respective start images after the start images of the recorded material are extracted.

7. The apparatus of claim 1, the controlling unit displays the start images extracted by the recording managing unit when the list of the recorded material is displayed on the displaying unit, and replays the recorded material from the replay time relative to the start image selected by the user.

8. The apparatus of claim 7, wherein when the recorded material is replayed, the controlling unit displays a time information of the replay on the displaying unit, wherein the time information of the replay is based on the start time of the recorded material.

9. An method for displaying, comprising:
dividing a recorded material stored in a memory into a plurality of recorded materials, and extracting images corresponding to start times of the respective divided recorded materials;
storing the extracted images as preview images of the recorded material;
displaying the preview images together when a list of the recorded material is displayed on the displaying unit; and
replaying the recorded material from a selected preview image when any one of the preview images is selected.

10. The method of claim 9, further comprising setting a point for generation of the preview images of the recorded material according to a user command before the dividing of the recorded material and the extracting of the preview images.

11. The method of claim 9, wherein in the displaying of the preview image, the preview image corresponding to the start time of the recorded material is displayed as a main image.

12. The method of claim 9, wherein in the displaying of the preview image, the preview images are arranged in an user interface including the list in a time order on the basis of the replay time.
